(19) United States
(12) Patent Application Publication
(10) Pub. No.: US 2026/0014976 A1
(43) Pub. Date: Jan. 15, 2026

(54) METHOD TO CONTROL AXLE TORQUES FOR HYBRID ELECTRIC ALL WHEEL DRIVE APPLICATIONS

(71) Applicant: GM Global Technology Operations LLC, Detroit, MI (US)

(72) Inventors: Dingguo Lu, Novi, MI (US); Kee Y. Kim, Ann Arbor, MI (US); Sandhu Kurian, Wixom, MI (US); Krunal P. Patel, South Lyon, MI (US); Lawrence A. Kaminsky, White Lake, MI (US); Anthony H. Heap, Ann Arbor, MI (US); Yiran Hu, Shelby Twp, MI (US)

(21) Appl. No.: 18/768,439

(22) Filed: Jul. 10, 2024

(51) Int. Cl. B60W 20/15; B60W 10/06; B60W 10/08; B60W 30/188; B60W 50/06

(52) U.S. Cl. CPC B60W 20/15; B60W 10/06; B60W 10/08; B60W 30/188; B60W 50/06

(57) ABSTRACT

A system performs a method for operating a vehicle. A raw total axle torque request for the vehicle is received at a processor of the vehicle. The vehicle includes a primary axle, one or more electric motors on the primary axle, an engine coupled to the primary axle, a secondary axle, and an additional electric motor on the secondary axle. The processor performs an optimization to determine a primary axle torque target and a secondary axle torque target that meets the raw total axle torque request while locating a value representative of a minimum of an objective cost function for the vehicle, controls the one or more electric motors and the engine at the primary axle using the primary axle torque target; and controls the additional electric motor at the secondary axle using the secondary axle torque target.

The subject disclosure relates to operation of hybrid vehicles, and in particular to a system and method of determining a torque split between a primary axle of the hybrid vehicle and a secondary axle of the hybrid vehicle that maintains a total torque requested of the vehicle.

A hybrid vehicle includes an internal combustion engine and one or more electric motors for powering the vehicle. Torque can be allocated between a primary axle that operates front wheels and secondary axle that operates rear wheels. As a vehicle's objective changes, torque requirements on the primary axle and on the secondary axle also change. If these torque requirements are not known, the vehicle can be operated at sub-optimal torque set points. Determining an optimal torque split between the primary axle and the secondary axle is inherently a multi-variable optimization problem which is difficult to solve in real-time. Accordingly, it is desirable to provide a method solvable in real-time for determining an optimal torque split between primary axle and secondary axle based on torque requirements.

### SUMMARY

In one exemplary embodiment, a method of operating a vehicle is disclosed. A raw total axle torque request for the vehicle is received at a processor of the vehicle. The vehicle includes a primary axle, one or more electric motors on the primary axle, an engine coupled to the primary axle, a secondary axle, and an additional electric motor on the secondary axle. An optimization is performed at the processor to determine a primary axle torque target and a secondary axle torque target that meets the raw total axle torque request while locating a value representative of a minimum of an objective cost function for the vehicle. The primary axle is controlled using the primary axle torque target at the one or more electric motors and the engine. The secondary axle is controlled using the secondary axle torque target at the additional electric motor.

In addition to one or more of the features described herein, performing the optimization further generates a secondary axle reserved power, further comprising using the secondary axle reserved power to determine an operating point of the engine and the one or more electric motors coupled to the primary axle and to generate the primary axle torque target.

In addition to one or more of the features described herein, the method further includes determining a shaped total axle torque request from the primary axle torque target and the secondary axle torque target, determining a desired primary axle torque from the primary axle torque target, the secondary axle torque and the shaped total axle torque request, determining a desired secondary axle torque from the primary axle torque, the secondary axle torque and the shaped total axle torque request, determining a primary axle torque command and a primary axle power used from the desired primary axle torque and the secondary axle reserved power, determining a secondary axle torque command from the primary axle torque command, the primary axle power used and the desired secondary axle torque, controlling the primary axle using the primary axle torque command, and controlling the secondary axle using the secondary axle torque command.

In addition to one or more of the features described herein, the method further includes determining a total axle torque command from the primary axle torque command and the secondary axle torque command and determining the shaped total axle torque request at a subsequent time using the total axle torque command.

In addition to one or more of the features described herein, the method further includes filling the raw total axle torque request using the secondary axle torque command when the primary axle torque command does not meet the desired primary axle torque.

In addition to one or more of the features described herein, the method further includes adjusting the axle torque split between the primary axle and the secondary axle to control a sum of the primary axle torque target and the secondary axle torque target.

In addition to one or more of the features described herein, the method further includes maintaining a charge-neutral flow of current at a high voltage battery that provides the current to the one or more electric motors and the additional electric motor.

In another exemplary embodiment, a system for operating a vehicle is disclosed. The system includes a processor configured to receive a raw total axle torque request for the vehicle, the vehicle including a primary axle, one or more electric motors on the primary axle, an engine coupled to the primary axle, a secondary axle, and an additional electric motor on the secondary axle, perform an optimization to determine a primary axle torque target and a secondary axle torque target that meets the raw total axle torque request while locating a value representative of a minimum of an objective cost function for the vehicle, control the one or more electric motors and the engine at the primary axle using the primary axle torque target; and control the additional electric motor at the secondary axle using the secondary axle torque target.

In addition to one or more of the features described herein, wherein the processor is further configured to perform the optimization by generating a secondary axle reserved power and the processor is further configured to use the secondary axle reserved power to determine an operating point of the engine and the one or more electric motors coupled to the primary axle and to generate the primary axle torque target.

In addition to one or more of the features described herein, the processor is further configured to determine a shaped total axle torque request from the primary axle torque target and the secondary axle torque target, determine a desired primary axle torque from the primary axle torque target, the secondary axle torque and the shaped total axle torque request, determine a desired secondary axle torque from the primary axle torque, the secondary axle torque and the shaped total axle torque request, determine a primary axle torque command and a primary axle power used from the desired primary axle torque and the secondary axle reserved power, determine a secondary axle torque command from the primary axle torque command, the primary axle power used and the desired secondary axle torque, control the primary axle using the primary axle torque command, and control the secondary axle using the secondary axle torque command.

In addition to one or more of the features described herein, the processor is further configured to determine a total axle torque command from the primary axle torque command and the secondary axle torque command and determine the shaped total axle torque request at a subsequent time using the total axle torque command.

In addition to one or more of the features described herein, the processor is further configured to fill the raw total axle torque request using the secondary axle reserved power when the primary axle torque command does not fill the desired primary axle torque.

In addition to one or more of the features described herein, the processor is further configured to adjust an axle torque split between the primary axle and the secondary axle to control a sum of the primary axle torque target and the secondary axle torque target.

In addition to one or more of the features described herein, the processor is further configured to maintain a charge-neutral flow of current at a high voltage battery that provides the current to the one or more electric motors and the additional electric motor.

In yet another exemplary embodiment, a vehicle is disclosed. The vehicle includes a primary axle, one or more electric motors on the primary axle, a secondary axle, an additional electric motor on the secondary axle, an engine, and a processor. The processor is configured to receive a raw total axle torque request for the vehicle, perform an optimization to determine a primary axle torque target and a secondary axle torque target that meets the raw total axle torque request while locating a value representative of a minimum of an objective cost function for the vehicle, control the one or motors of the primary axle using the primary axle torque target, and control the additional electric motor of the secondary axle using the secondary axle torque target.

In addition to one or more of the features described herein, the processor is further configured to perform the optimization by generating a secondary axle reserved power and the processor is further configured to use the secondary axle reserved power to determine an operating point of the engine and the one or more electric motors coupled to the primary axle and to generate the primary axle torque target.

In addition to one or more of the features described herein, the processor is further configured to determine a shaped total axle torque request from the primary axle torque target and the secondary axle torque target, determine a desired primary axle torque from the primary axle torque target, the secondary axle torque and the shaped total axle torque request, determine a desired secondary axle torque from the primary axle torque, the secondary axle torque and the shaped total axle torque request, determine a primary axle torque command and a primary axle power used from the desired primary axle torque and the secondary axle reserved power, determine a secondary axle torque command from the primary axle torque command, the primary axle power used and the desired secondary axle torque, control the primary axle using the primary axle torque command, and control the secondary axle using the secondary axle torque command.

In addition to one or more of the features described herein, the processor is further configured to determine a total axle torque command from the primary axle torque command and the secondary axle torque command and determine the shaped total axle torque request at a subsequent time using the total axle torque command.

In addition to one or more of the features described herein, the processor is further configured to fill the raw total axle torque request using the secondary axle reserved power when the primary axle torque command does not fill the desired primary axle torque.

In addition to one or more of the features described herein, the processor is further configured to adjust an axle torque split between the primary axle and the secondary axle to control a sum of the primary axle torque target and the secondary axle torque target.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a plan view of a hybrid vehicle in accordance with an exemplary embodiment;

FIG. 2 is a block diagram illustrating a method for splitting a raw total axle torque request between a primary axle torque command applied to the primary axle and a secondary axle torque command provided to a secondary axle;

FIG. 3 shows a flowchart of a method for operating the hybrid vehicle, in an illustrative embodiment;

FIG. 4 shows a workflow of parameters used to determine a primary axle torque command and a secondary axle torque command, in an illustrative embodiment;

FIG. 5 shows a block diagram illustrating details of the torque target optimization stage and the torque arbitration and shaping stage of FIG. 2;

FIGS. 6A, 6B, 6C, and 6D is a flowchart illustrating a method for determining a split between an optimized primary axle torque target and an optimized secondary axle torque target for the vehicle, in an illustrative embodiment;

FIG. 7 shows a flow chart of a method for determining an optimized value of primary axle torque, in an illustrative embodiment;

FIG. 8 is a flowchart of a method for determining a secondary axle torque control command; and

FIG. 9 shows a graph of various torque parameters of the vehicle over time.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

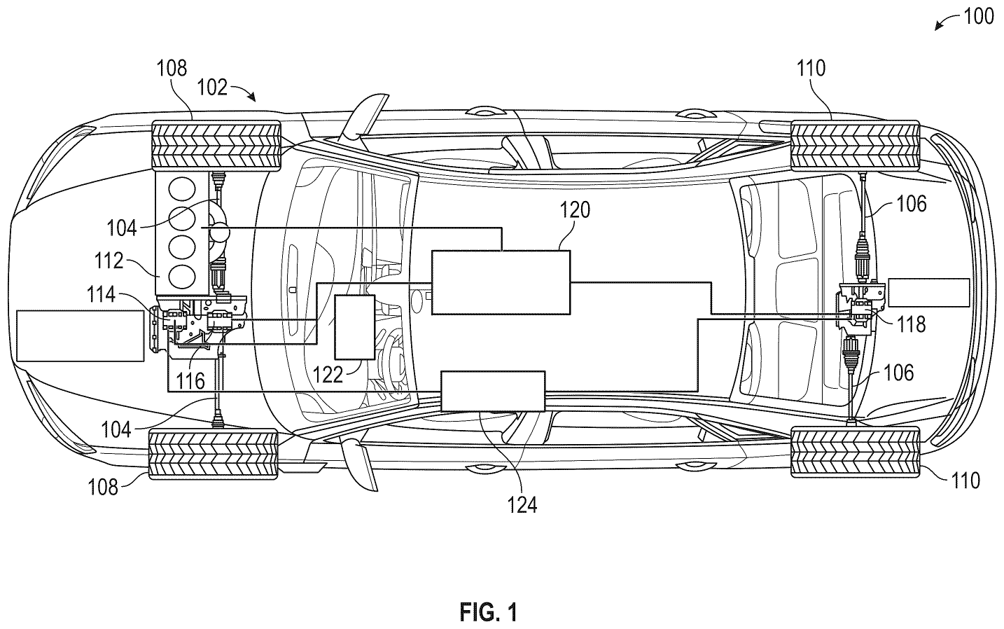

In accordance with an exemplary embodiment, FIG. 1 shows a plan view 100 of a hybrid vehicle 102. The hybrid vehicle 102 includes a primary axle 104 (i.e., a front axle) and a secondary axle 106 (i.e., a rear axle). The primary axle 104 is connected to front wheels 108 and the secondary axle 106 is connected to rear wheels 110. An internal combustion engine 112 (ICE) and one or more electric motors 114, 116 are connected to the primary axle 104. When the vehicle is operating in an internal combustion mode or hybrid mode, the internal combustion engine 112 provides a torque to the primary axle 104, which transmits the torque to the front wheels 108. In hybrid mode part of internal combustion engine's torque is converted to electrical power via an electrical motor and is either used to power another electrical motor or stored into the battery. When the vehicle is operating in an electric vehicle (EV) mode, the one or more electric motors 114, 116 provide a torque to the primary axle 104 which is transmitted to front wheels 108. An additional electric motor 118 is coupled to the secondary axle 106. The additional electric motor 118 can provide torque to the secondary axle 106, which transmits the torque to the rear wheels 110. The additional electric motor 118 can include one or more electric motors.

The hybrid vehicle 102 further includes a controller 120 that controls operation of the internal combustion engine 112 (ICE), the one or more electric motors 114, 116 and the additional electric motor 118 on the secondary axle 106. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 120 may include a non-transitory computer-readable medium that stores instructions which, when processed by one or more processors of the controller 120, implement a method of determining a torque split between the primary axle 104 and the secondary axle 106 that optimizes the optimization objective cost for the vehicle, according to one or more embodiments detailed herein. Determining a torque split is a multi-variable optimization problem which involves forming an objective cost function and performing an optimization procedure on the object cost function to locate torque values that minimizes the optimization objective cost.

The hybrid vehicle 102 further includes a high voltage battery 124 that provides electric current to the one or more electric motors 114, 116 and to the additional electric motor 118 on the secondary axle 106.

In an embodiment, the hybrid vehicle 102 is an autonomous vehicle including an autonomous driving system 122 for controlling operation of the vehicle and actuators such as a steering wheel and an accelerator pedal. The autonomous driving system 122 can provide a torque request to be implemented based on various calculations. In another embodiment, the vehicle can be manually operated. In manual operation, a driver can provide the torque request via the accelerator pedal.

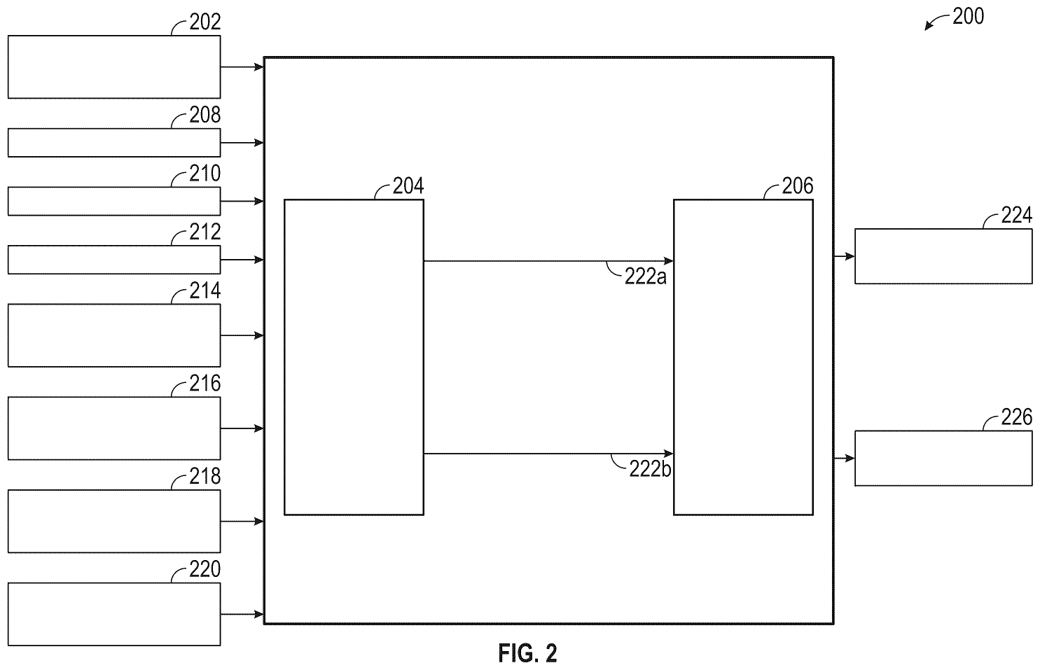

FIG. 2 is a block diagram 200 illustrating a method for splitting a raw total axle torque request 202 between a primary axle torque command 224 applied to the primary axle 104 and a secondary axle torque command 226 provided to a secondary axle 106. The method includes a torque target optimization stage 204 and a torque arbitration and shaping stage 206. The method operates using various input parameters, including the raw total axle torque request 202, vehicle speed 208, component hardware limits 210, a desired chassis split 212 (and chassis axle torque limits), fuel economy objectives 214, component hardware loss characterization 216, axle safety torque limits 218, and drive quality requirements 220.

The raw total axle torque request 202 is a total torque that is requested by either the driver of the vehicle or an autonomous system of the vehicle. The vehicle speed 208 can be provided by a speedometer of the vehicle. Component hardware limits 210 can include engine limits, clutch limits, motor limits, battery limits, etc. These limits can be stored in a memory location or database. The desired chassis split 212 is a desired split of torque amongst the primary axle 104 and the secondary axle 106. The desired chassis split 212 can include selected values of torque within limits for each axle. Fuel economy objectives 214 includes SOC control objectives and can be stored in a memory or a database. The component hardware loss characterization 216 includes characterization of engine loss, electric motor and inverter loss, transmission loss, battery loss, etc. Axle safety torque limits 218 and drive quality requirements 220 can be stored in a memory or a database.

The torque target optimization stage 204 generates an optimized primary axle torque target 222a and an optimized secondary axle torque target 222b, as well as other parameters and provides these to the torque arbitration and shaping stage 206. The torque arbitration and shaping stage 206 generates the primary axle torque command 224 and the secondary axle torque command 226 which are provided to the primary axle 104 and the secondary axle 106, respectively.

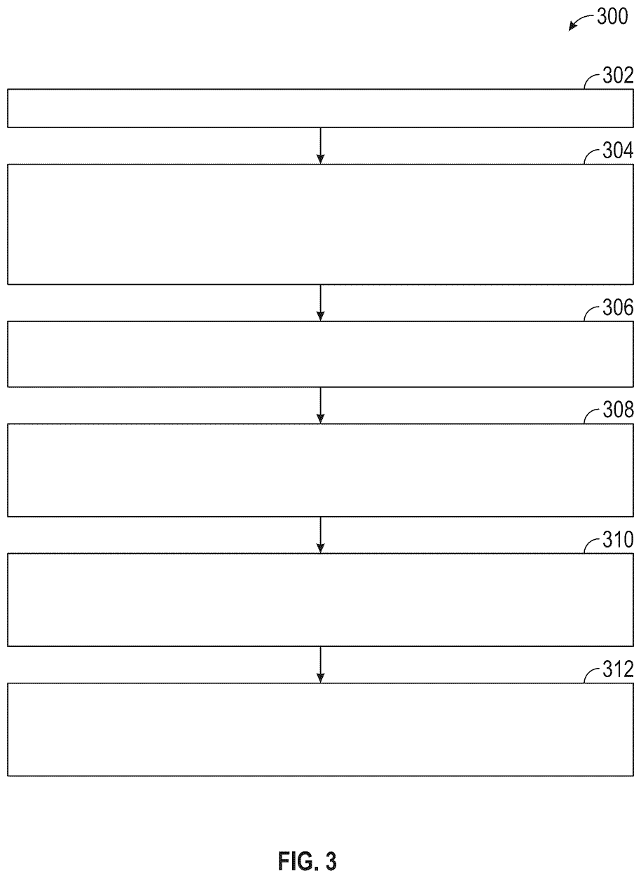

FIG. 3 shows a flowchart 300 of a method for operating the hybrid vehicle, in an illustrative embodiment. In box 302, a raw total axle torque request is received, either from a driver or from the autonomous driving system 122. In box 304, an online optimization process is performed to determine an optimized primary axle torque target and an optimized secondary axle torque target that optimizes the optimization objective cost to the vehicle. The optimized objective cost is a minimum optimization objective cost or a value selected as a result of the online optimization process to represent a minimum optimization objective cost. The online optimization process also outputs secondary axle reserved power. In box 306, a shaped total torque request is calculated from the optimized primary axle torque target and the optimized secondary axle torque target. In box 308, the optimized primary axle torque target, the optimized secondary axle torque target and the shaped total torque request are used to calculate a desired primary axle torque and a desired secondary axle torque. In box 310, the primary axle torque command and the secondary axle reserved power are used to calculate a primary axle torque command and a primary axle power used. In box 312, the primary axle torque command, the primary axle power used, and the desired secondary axle torque are used to calculate a secondary axle torque command.

The primary axle torque command and the secondary axle torque command can be summed to generate a total axle torque command. The total axle torque command can be used (along with a subsequent optimized primary axle torque target and a subsequent optimized secondary axle torque target) to generate the shaped axle torque request at a subsequent time.

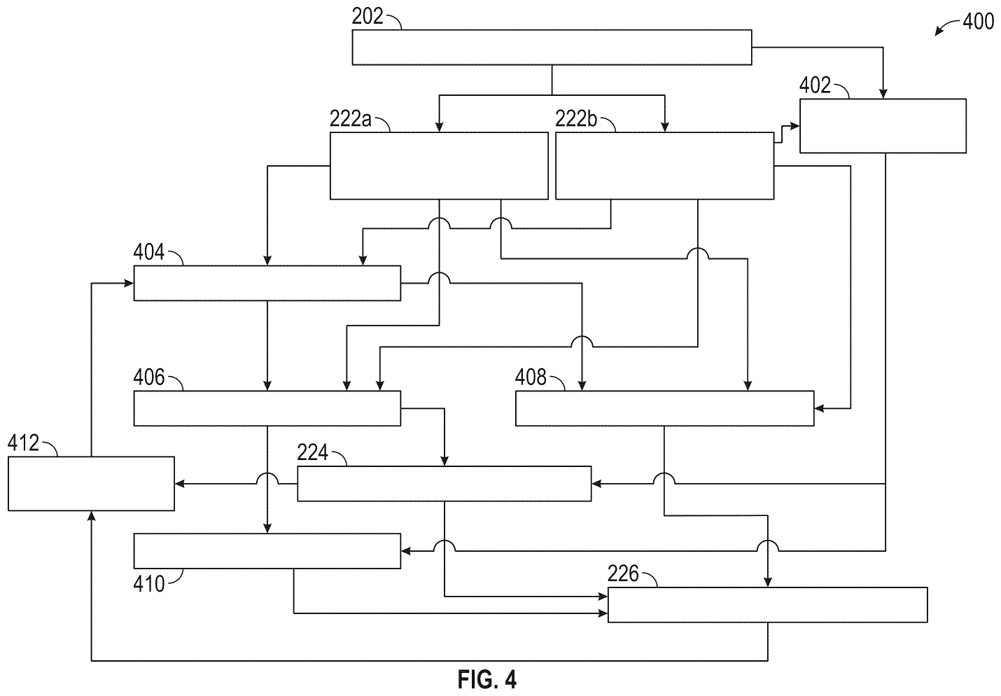

FIG. 4 shows a workflow 400 of parameters used to determine a primary axle torque command 224 and a secondary axle torque command 226 in an illustrative embodiment. A raw total axle torque request 202 is received. The raw total axle torque request 202 is used to generate an optimized primary axle torque target 222a and an optimized secondary axle torque target 222b. The optimized secondary axle torque target 222b is used to determine a secondary axle reserved power 402. The optimized primary axle torque target 222a and the optimized secondary axle torque target 222b are used to create a shaped total axle torque request 404. The shaped total axle torque request 404 is applied to the optimized primary axle torque target 222a and the optimized secondary axle torque target 222b to generate a desired primary axle torque 406 and a desired secondary axle torque 408.

The secondary axle reserved power 402 and the desired primary axle torque 406 are used to generate the primary axle torque command 224 and a primary axle power used 410, which is an amount of power used by the primary axle 104. The primary axle torque command 224 can be applied to the primary axle 104.

Once the primary axle torque command 224 and the primary axle power used 410 have been determined, the secondary axle torque command 226 can be determined. The desired secondary axle torque 408, the primary axle torque command 224 and the primary axle power used 410 generate the secondary axle torque command 226. The secondary axle torque command 226 can be applied to the secondary axle 106. The primary axle torque command 224 and the secondary axle torque command 226 can be added to produce a total axle torque command 412. The total axle torque command 412 can be used with the optimized primary axle torque target 222a and the optimized secondary axle torque target 222b to generate the shaped total axle torque request 404.

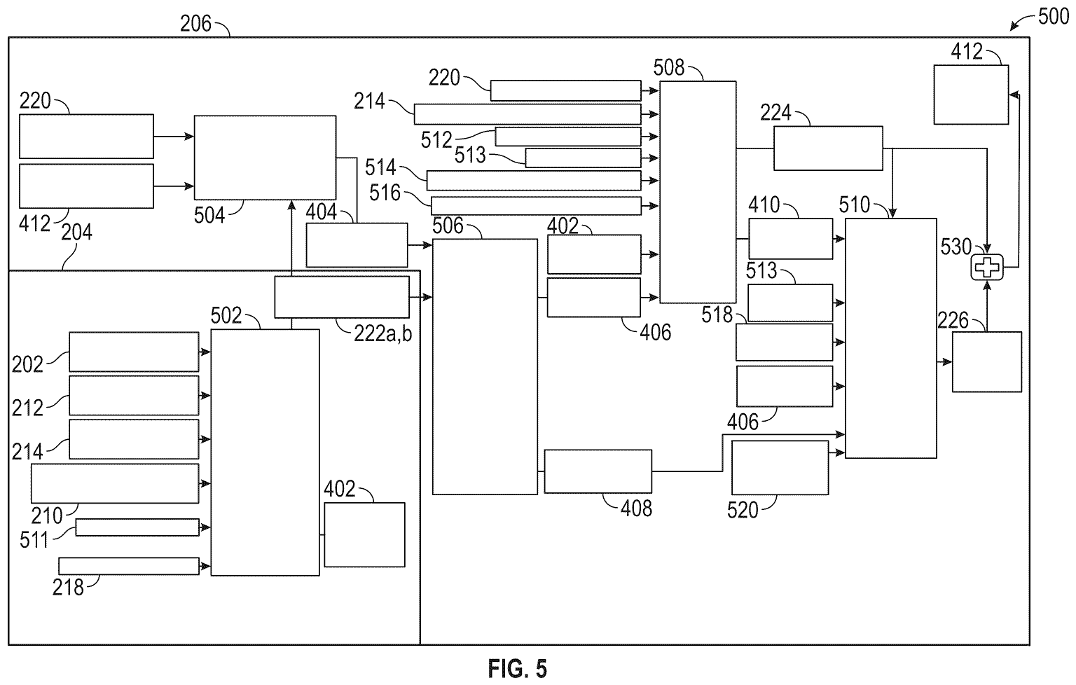

FIG. 5 shows a block diagram 500 illustrating details of the torque target optimization stage 204 and the torque arbitration and shaping stage 206 of FIG. 2. The block diagram 500 shows the torque target optimization stage 204 and the torque arbitration and shaping stage 206. The torque target optimization stage 204 includes operation of a torque target calculation module 502. The torque arbitration and shaping stage 206 includes operation of a total axle torque shaping module 504, a desired torque calculation module 506, a primary axle torque command module 508 and a secondary axle torque command module 510. In an embodiment, these modules can be operated on the processor of the controller 120.

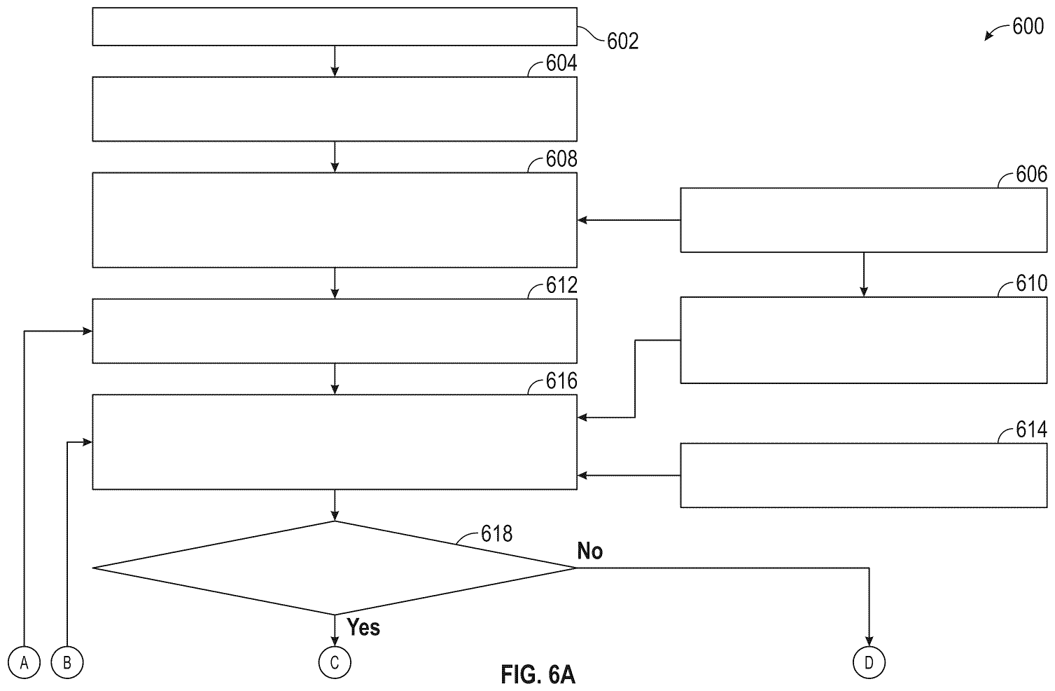

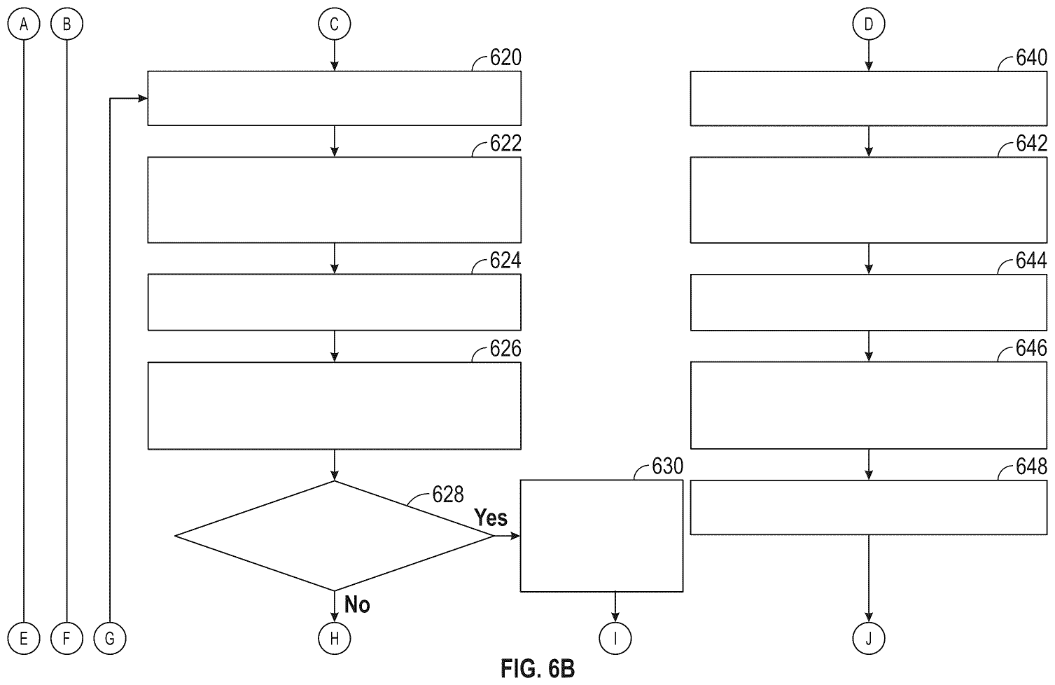

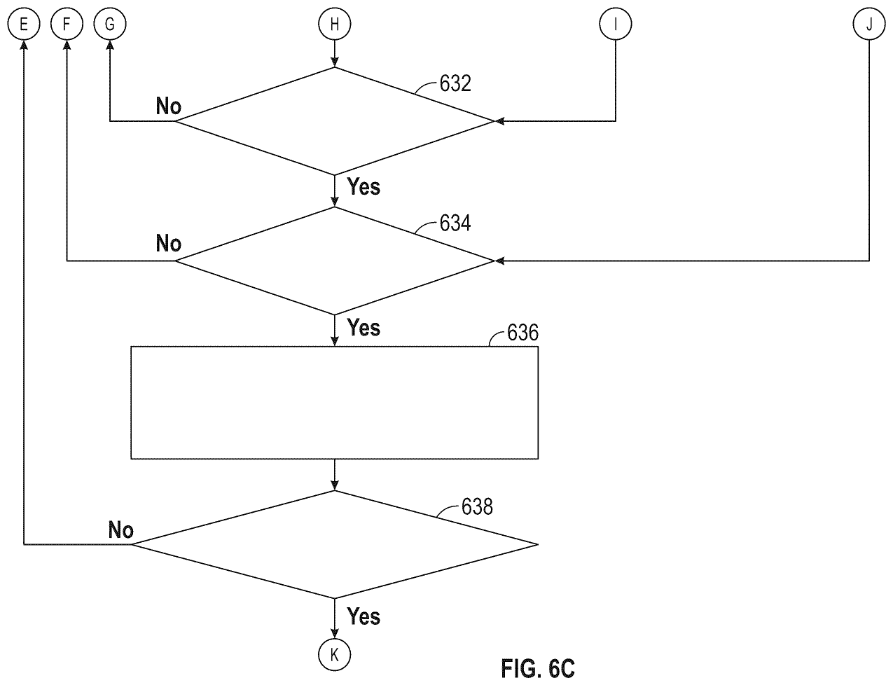

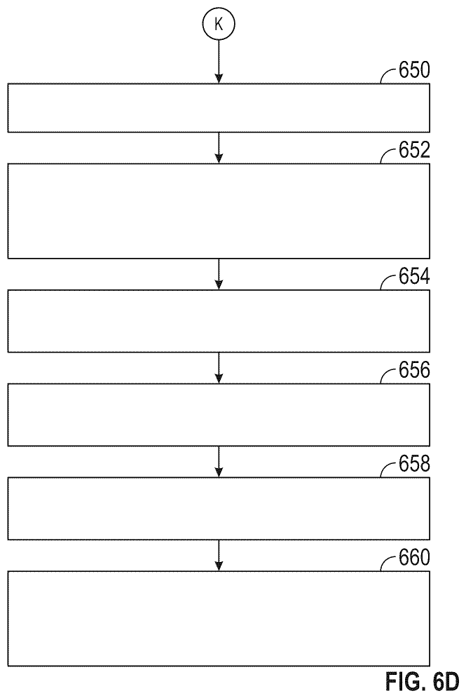

The torque target calculation module 502 receives the raw total axle torque request 202, the component hardware limits 210, the desired chassis split 212, the fuel economy objectives 214, HV battery SOC limits 511, and axle safety torque limits 218 and calculates the optimized primary axle torque target 222a, the optimized secondary axle torque target 222b, and the secondary axle reserved power 402. The torque target calculation module 502 calculates a desired torque split amongst the primary and secondary axles that meets the raw total axle torque request in accordance with various constraints and limits of the axles, motors, engines, clutch, etc. The torque target calculation module 502 outputs the optimized primary axle torque target 222a, the optimized secondary axle torque target 222b and the secondary axle reserved power 402. Details of operation of the torque target calculation module 502 are discussed herein with respect to FIGS. 6A-D.

In the torque arbitration and shaping stage 206, the optimized primary axle torque target 222a and optimized secondary axle torque target 222b are sent to both the total axle torque shaping module 504 and to the desired torque calculation module 506. The secondary axle reserved power 402 is sent to the primary axle torque command module 508.

The total axle torque shaping module 504 derives a shaped total axle torque request 404 based on the optimized primary axle torque target 222a, the optimized secondary axle torque target 222b, the drive quality requirements 220 and a previously determined total axle torque command 412 and derives the shaped total axle torque request 404 based on these inputs. The shaped total axle torque request 404 is provided to the desired torque calculation module 506.

The desired torque calculation module 506 calculates the desired primary axle torque 406 and the desired secondary axle torque 408 by arbitrating between the shaped total axle torque request 404, the optimized primary axle torque target 222a and the optimized secondary axle torque target 222b. The desired primary axle torque 406 is provided to the primary axle torque command module 508. The desired secondary axle torque 408 is provided to the secondary axle torque command module 510.

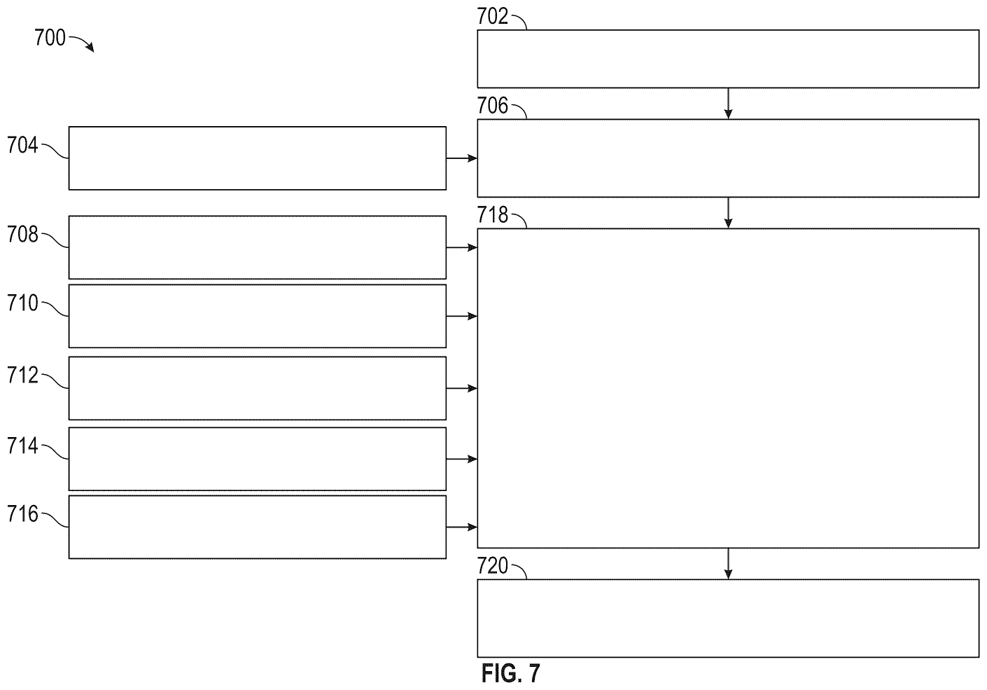

Inputs to the primary axle torque command module 508 include the drive quality requirements 220, the fuel economy objectives 214, the primary axle motor limit 512, total battery limits 513 (which is part of the component hardware limits 210), the hybrid transmission component limits 514, the primary lash status and rate limits 516, the secondary axle reserved power 402 (from the torque target calculation module 502), and the desired primary axle torque 406 (from the desired torque calculation module 506). The primary axle torque command module 508 outputs the primary axle torque command 224 and the primary axle power used 410, both of which are provided to the secondary axle torque command module 510. A detailed operation of the primary axle torque command module 508 is discussed herein with respect to FIG. 7.

The secondary axle torque command module 510 receives the primary axle torque command 224, the primary axle power used 410, the desired secondary axle torque 408, the total battery limits 513, secondary axle torque limits 518, the desired primary axle torque 406, and the secondary lash status and rate limits 520. The secondary axle torque command module 510 outputs the secondary axle torque command 226.

The primary axle torque command 224 can be applied to the primary axle 104 and the secondary axle torque command 226 can be applied to the secondary axle 106. In addition, a summing circuit 530 adds the primary axle torque command 224 to the secondary axle torque command 226 to output a total axle torque command 412. The total axle torque command 412 is provided as input to the total axle torque shaping module 504 for generating a subsequent shaped total torque request.

FIGS. 6A-D is a flowchart 600 illustrating a method for determining a split between an optimized primary axle torque target and an optimized secondary axle torque target for the vehicle, in an illustrative embodiment. This method occurs in the torque target calculation module 502. In box 602, the raw total axle torque request 202 is received. In box 604, safety limits are applied to the raw total axle torque request 202 to output a safety-limited torque request.

In box 606, a desired chassis split 212 is received. In box 608, the safety-limited torque request is split into a primary axle torque request and a secondary axle torque request based on the desired torque split and the axle torque limits. In box 610, a secondary axle reserved power 402 is calculated for the desired torque split.

Box 612 marks a starting point for a first iteration loop through a plurality of propulsion range states (or operating modes) for the vehicle. In box 612, an allowed propulsion range state is selected from the plurality of range states.

In box 614, battery power limits and secondary axle power limits are obtained. These are provided to box 616. Box 616 marks a starting point for a second iteration loop through a range of possible axle torque splits. The battery power limits and secondary axle power limits obtained in box 614 are used in box 616 to define the range of possible axle torque splits. Electric power limits at the primary axle can be calculated from a difference between the battery power limits and the secondary axle reserved power for a selected torque split, as indicated in Eq. (1):

$$Electric power limits ( primary axle ) = battery power limits - secondary axle resserved power \qquad Eq . ( 1 )$$

From box 616, the method proceeds to box 618.

In box 618, the operating mode of the vehicle is checked (i.e., whether the vehicle is operating in a mode in which engine speed can be changed). If the engine speed can be changed, the method proceeds along branch A. If the engine speed cannot be changed, the method proceeds along branch B.

Branch A involves a third iteration loop. Box 620 marks a starting point for the third iteration loop through a range of engine speeds. In box 620, an engine speed is selected from the range of engine speeds. In box 622, hardware constraints are determined for the engine speed. These constraints include motor speed limits, clutch torque limits, drive unit gearing speed limits, engine hardware limits, idle stability, lubrication and cooling, etc. In box 624, the primary axle torque limits are calculated as a sum of total axle limits and selected secondary axle torque (from box 616) as shown, for example, in Eq. (2):

$$total axle torque limits = primary axle torque limits + secondary axle torque \qquad Eq . ( 2 )$$

In box 626, an online optimization process is performed on an objective function using to locate a selected engine speed, secondary axle torque, and primary axle torque that minimizes an optimization objective cost for the vehicle.

In box 628, a decision is made based on the value of the optimization objective cost. If this is the first iteration through the third iteration loop or if a lower cost has been found, then the method proceeds to box 630. Otherwise, the method proceeds to box 632. In box 630, the results of the online optimization are saved, including the determined optimization objective cost, the engine speed, and the secondary axle torque resulting from the online optimization process. The method then proceeds to box 632.

Box 632 marks an end point for the third iteration loop. In box 632, if the last engine speed of the third iteration loop has not been reached, the method returns to box 620 for a next iteration through the third iteration loop. Otherwise, the method proceeds to box 634.

Box 634 marks an end point for the second iteration loop. In box 634, if the last secondary axle power of the second iteration loop has not been reached, the method returns to box 616 for a next iteration through the second iteration loop. Otherwise, the method proceeds to box 636. In box 636, results are saved. These results include the optimal secondary axle torque, the optimal primary axle torque, and the minimized optimization objective cost for the associated range state. The method then proceeds to box 638.

Box 638 marks an end point for the first iteration loop. In box 638, if the last range state has not been reached, the method returns to box 612 for another iteration through the first iteration loop. Otherwise, the method continues to box 650 (branch C).

Turning now to branch B, in box 640, the engine speed corresponding to the range state is determined. In box 642, a determination is made of other components' speeds, as well as engine torque limits, motor torque limits, and clutch torque limits. In box 644, the primary axle torque limits are calculated (see Eq. (2)).

In box 646, an online optimization process is performed in real time to locate a selected engine speed, secondary axle torque, and primary axle torque that minimizes an optimization objective cost for the vehicle. In box 648, results are saved, including the determined optimization objective cost and the secondary axle torque associated with the engine speed resulting from the online optimization process. The method then proceeds to box 634.

Turning now to branch C. In box 650, the range state with the lowest optimization objective cost is determined. In box 652, the optimal primary axle torque and the optimal secondary axle torque corresponding to the lowest optimization objective cost are output. In box 654, the primary axle torque and the secondary axle torque are limited to values within a safety control boundary. If the value of either of these torques are outside of the safety control boundary, this value can be replaced by the limit of the safety control boundary. In box 656, a primary brake intervention is applied to the primary axle torque. In box 658, a final value for the secondary axle reserved power is calculated. In box 660, the optimized primary axle torque target, the optimized secondary axle torque target, and the secondary axle reserved power are output.

FIG. 7 shows a flow chart 700 of a method for determining an optimized value of primary axle torque, in an illustrative embodiment. In box 702, the final secondary axle reserved power is received (from box 660 of the flowchart 600 of FIG. 6). In box 704, battery power limits are received. In box 706, primary axle power limits are calculated as a difference in battery power limits and the secondary axle reserved power, as shown, for example, in Eq. (3):

$$Primary Axle Power Limits = Battery Power Limits - Secondary Axle reserved power final \qquad Eq . ( 3 )$$

In box 708, the primary axle torque is received. In box 710, the component hardware limits, engine limits, motor limits, and clutch limits are received. In box 712, state of charge (SOC) control requirements are received. In box 714, drive quality requirements are received. In box 716, regulatory requirements are received. In box 718, the primary axle drive unit is optimized to meet an optimization objective for the primary axle based on primary axle torque, component hardware limits, SOC control requirements, drive quality requirements, and regulatory requirements. The online optimization includes primary axle optimization costs. Such costs include a penalty cost for violation of primary power limits, a penalty cost for violation of motor torque limits, a penalty cost for violation of clutch torque limits, a penalty cost for violation of engine torque limits, a cost for under producing or over producing a primary axle torque target, a cost for SOC control, a cost for violating NVH (Noise, Vibration, Harshness) bounds, a total system loss at a selected operation point, and a cost to meet regulatory and drive quality requirements.

In box 720, the optimized engine speed, optimized engine torque and optimized operation mode are output as an operating point for the vehicle. The operating point can be a point that maintains a charge-neutral flow of current at a high voltage battery of the vehicle that provides the current to the one or more electric motors and the additional electric motor.

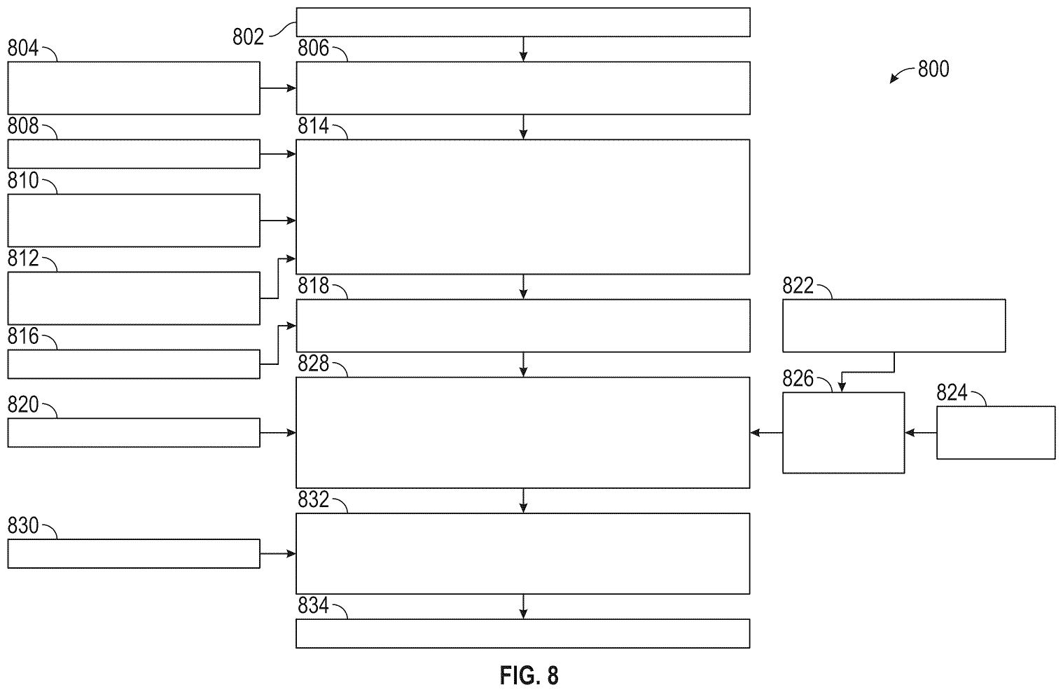

FIG. 8 is a flowchart 800 of a method for determining a secondary axle torque control command. In box 802, the desired secondary axle torque 318 is received. In box 804, a brake module secondary intervention is received. In box 806, the secondary brake intervention is applied to the desired secondary axle torque. In box 808, the desired primary axle torque is received. In box 810, a constrained primary axle torque is received. In box 812, a brake module primary intervention is received. In box 814, a first limited secondary axle torque is calculated, as shown in Eq. (4):

$$first limited secondary axle torque = desired secondary axle torque + primary axle torque ( shaped ) - arbitrated primary axle torque \qquad Eq . ( 4 )$$

In box 816, the chassis secondary limit is received. In box 818, a second limited secondary axle torque is generated by applying the chassis secondary limit to the first limited secondary axle torque. In box 820, a secondary motor limit is received. In box 822, the primary axle power used is received. In box 824, total power battery limits are received. In box 826, left-over battery power limits are calculated using, for example, Eq. (5):

$$secondary power limits = total battery power limits - primary axle power used \qquad Eq . ( 5 )$$

In box 828, a third limited secondary axle torque is calculated based on the secondary limited secondary torque, the secondary motor limit and the secondary battery power limits. In box 830, safety control limits are received. In box 832, the third limited secondary axle torque is limited to within the secondary torque safety limits, resulting in the secondary axles torque command. In box 834, the secondary axle torque command is output.

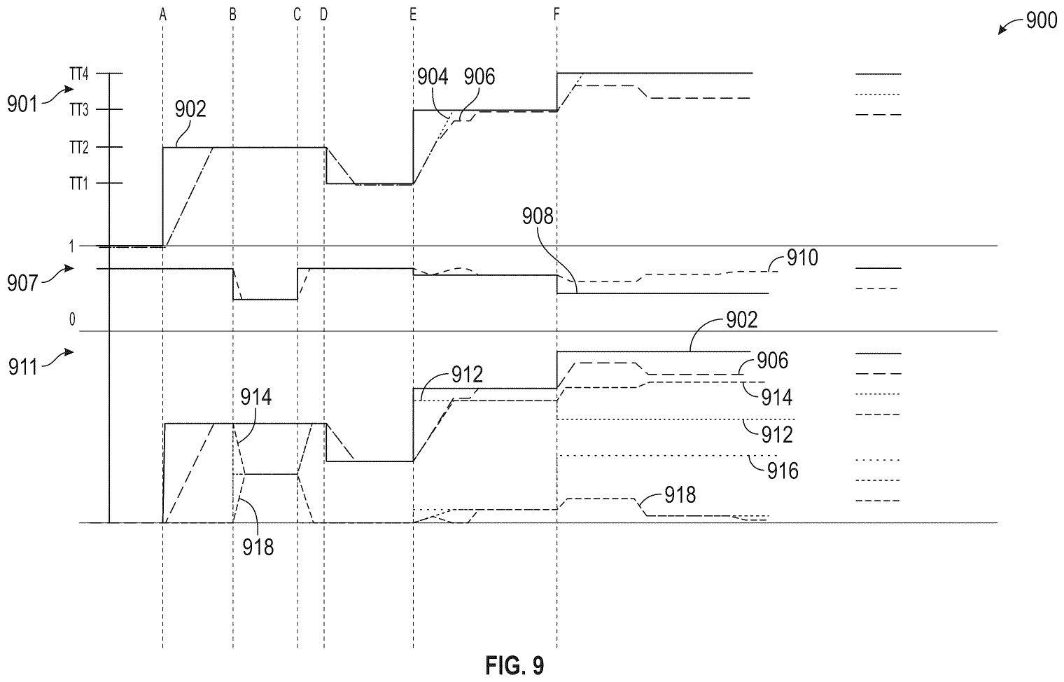

FIG. 9 shows a graph 900 of various torque parameters of the vehicle over time. Time is shown along the abscissa and torque is shown along the ordinate axis. A first graph 901 shows different total torques used in determining a torque split. A second graph 907 shows different torque split ratios. A third graph 911 shows primary axle torque values and secondary axle torque values. The first graph 901, the second graph 907 and the third graph 911 share a common time axis.

The first graph 901 includes a first curve 902, a second curve 904 and a third curve 906. The first curve 902 indicates a raw total axle torque request, such as received at the torque target calculation module 502. The second curve 904 indicates a shaped total axle torque request, such as output by the total axle torque shaping module 504. The third curve 906 indicates a final commanded value of the total torque.

The first curve 902 increases from zero to a second total torque value (TT2) at time A and remains at that value until time D. At time D, the first curve 902 decreases to a first total torque value TT1. At time E, the first curve 902 increases to a third total torque value (TT3). At time F, the first curve 902 increases to a fourth total torque value (TT4). The first curve 902 changes values instantaneously to form steps between total torque values.

The second curve 904 follows the first curve 902 with a delay that includes a linear change between the beginning torque values and the ending torque values. The delay represents a calibratable torque shaping that delivers a pleasing drive feel to the driver or passenger of the vehicle.

The second graph 907 includes a fourth curve 908 and a fifth curve 910. The fourth curve 908 indicates a primary axle ratio target. The fifth curve 910 indicates a final value of a primary axle ratio. The value of the fourth curve 908 changes based on a desired axle split request. For illustrative purposes, the value of the fourth curve 908 is at 1 up until time B, indicating that always torque power is at the primary axle torque. At time B, the value of the fourth curve 908 changes to 0.5. At time C, the value of the fourth curve 908 reverts to 1. At time E, the value of the fourth curve 908 changes to about 0.9. At time F, the value of the fourth curve 908 changes to about 0.7.

At time B, the value of the fifth curve 910 changes to from 1 to 0.5 to track the fourth curve 908. A linear sloped section indicates a delay between the fifth curve 910 and the fourth curve 908. At time C, the value of the fifth curve 910 changes back to 1, with a linear delay.

At time E, the value of the fifth curve 910 changes to 0.9. However, an engine start or an acceleration reduces the power available for electric all-wheel drive (eAWD). As power becomes available after the engine start or engine acceleration has completed, the secondary axle torque changes to the desired value (i.e., 0.9). At time F, the desired split is deviated to meet drive requested torque or to minimize a deviation. As the vehicle speed changes, the driver torque/max system capability is achieved at a different torque splits ratio. Hence torque split can be changed to meet the driver torque request without any input from the driver.

The third graph 911 includes the first curve 902, the third curve 906, a sixth curve 912, a seventh curve 914, an eighth curve 916 and a ninth curve 918. The sixth curve 912 indicates a primary axle torque target. The seventh curve 914 indicates a final primary axle torque. The eighth curve 916 indicates a secondary torque target. The ninth curve 918 indicates a final secondary torque.

The sixth curve 912 (primary torque target) is the same as the first curve 902 (total torque target) up until time B because the primary axle ratio target is 1. From time B to time C, the sixth curve 912 takes a value that is half of the first curve 902. The sixth curve 912 returns to the value of the first curve 902 from time C to time E. At time E, the sixth curve 912 takes 0.9 of the value of the first curve 902. At time F, the sixth curve 912 takes 0.8 of the value of the first curve.

The seventh curve 914 (primary torque final) tracks the sixth curve 912 up to time E, with a linear slope delay when the sixth curve 912 changes values. The linear slope delay represents a calibratable torque shaping for a pleasing driving experience for the driver. At time F, the seventh curve 914 deviates from the sixth curve 912 when total requested torque is above a total system torque capability. Under such conditions, torque split is optimized to provide maximum torque to the vehicle. A secondary axle intervention or capacity limit reduces the secondary torque, thereby changing the torque split ratio.

The eighth curve 916 (secondary torque target) is a complement of the sixth curve 912 (primary torque target), where the secondary torque target plus the primary torque target is equal to the total torque target (first curve 902).

The ninth curve 918 (final secondary torque) is a complement of the seventh curve 914 (primary torque target), where the final secondary torque plus the primary torque is equal to the total torque (third curve 906).

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
receiving, at a processor of the vehicle, a raw total axle torque request for the vehicle, the vehicle including a primary axle, one or more electric motors on the primary axle, an engine coupled to the primary axle, a secondary axle, and an additional electric motor on the secondary axle;
performing an optimization at the processor to determine a primary axle torque target and a secondary axle torque target that meets the raw total axle torque request while locating a value representative of a minimum of an objective cost function for the vehicle;
controlling the primary axle using the primary axle torque target at the one or more electric motors and the engine; and
controlling the secondary axle using the secondary axle torque target at the additional electric motor.

2. The method of claim 1, wherein performing the optimization further generates a secondary axle reserved power, further comprising using the secondary axle reserved power to determine an operating point of the engine and the one or more electric motors coupled to the primary axle and to generate the primary axle torque target.

3. The method of claim 2, further comprising:
determining a shaped total axle torque request from the primary axle torque target and the secondary axle torque target;
determining a desired primary axle torque from the primary axle torque target, the secondary axle torque target and the shaped total axle torque request;
determining a desired secondary axle torque from the primary axle torque target, the secondary axle torque target and the shaped total axle torque request;
determining a primary axle torque command and a primary axle power used from the desired primary axle torque and the secondary axle reserved power;
determining a secondary axle torque command from the primary axle torque command, the primary axle power used and the desired secondary axle torque;
controlling the primary axle using the primary axle torque command; and
controlling the secondary axle using the secondary axle torque command.

4. The method of claim 3, further comprising determining a total axle torque command from the primary axle torque command and the secondary axle torque command and determining the shaped total axle torque request at a subsequent time using the total axle torque command.

5. The method of claim 3, further comprising filling the raw total axle torque request using the secondary axle torque command when the primary axle torque command does not meet the desired primary axle torque.

6. The method of claim 1, further comprising adjusting an axle torque split between the primary axle and the secondary axle to control a sum of the primary axle torque target and the secondary axle torque target.

7. The method of claim 1, further comprising maintaining a charge-neutral flow of current at a high voltage battery that provides current to the one or more electric motors and the additional electric motor.

8. A system for operating a vehicle, comprising:
a processor configured to:
receive a raw total axle torque request for the vehicle, the vehicle including a primary axle, one or more electric motors on the primary axle, an engine coupled to the primary axle, a secondary axle, and an additional electric motor on the secondary axle;
perform an optimization to determine a primary axle torque target and a secondary axle torque target that meets the raw total axle torque request while locating a value representative of a minimum of an objective cost function for the vehicle;
control the one or more electric motors and the engine at the primary axle using the primary axle torque target; and
control the additional electric motor at the secondary axle using the secondary axle torque target.

9. The system of claim 8, wherein the processor is further configured to perform the optimization by generating a secondary axle reserved power and the processor is further configured to use the secondary axle reserved power to determine an operating point of the engine and the one or more electric motors coupled to the primary axle and to generate the primary axle torque target.

10. The system of claim 9, wherein the processor is further configured to:
determine a shaped total axle torque request from the primary axle torque target and the secondary axle torque target;
determine a desired primary axle torque from the primary axle torque target, the secondary axle torque target and the shaped total axle torque request;
determine a desired secondary axle torque from the primary axle torque target, the secondary axle torque target and the shaped total axle torque request;
determine a primary axle torque command and a primary axle power used from the desired primary axle torque and the secondary axle reserved power;
determine a secondary axle torque command from the primary axle torque command, the primary axle power used and the desired secondary axle torque;
control the primary axle using the primary axle torque command; and
control the secondary axle using the secondary axle torque command.

11. The system of claim 10, wherein the processor is further configured to determine a total axle torque command from the primary axle torque command and the secondary axle torque command and determine the shaped total axle torque request at a subsequent time using the total axle torque command.

12. The system of claim 10, wherein the processor is further configured to fill the raw total axle torque request using the secondary axle reserved power when the primary axle torque command does not fill the desired primary axle torque.

13. The system of claim 8, wherein the processor is further configured to adjust an axle torque split between the primary axle and the secondary axle to control a sum of the primary axle torque target and the secondary axle torque target.

14. The system of claim 8, wherein the processor is further configured to maintain a charge-neutral flow of current at a high voltage battery that provides current to the one or more electric motors and the additional electric motor.

15. A vehicle, comprising:
a primary axle;
one or more electric motors on the primary axle;
a secondary axle;
an additional electric motor on the secondary axle;
an engine;
a processor configured to:
receive a raw total axle torque request for the vehicle,
perform an optimization to determine a primary axle torque target and a secondary axle torque target that meets the raw total axle torque request while locating a value representative of a minimum of an objective cost function for the vehicle;
control the one or motors of the primary axle using the primary axle torque target; and
control the additional electric motor of the secondary axle using the secondary axle torque target.

16. The vehicle of claim 15, wherein the processor is further configured to perform the optimization by generating a secondary axle reserved power and the processor is further configured to use the secondary axle reserved power to determine an operating point of the engine and the one or more electric motors coupled to the primary axle and to generate the primary axle torque target.

17. The vehicle of claim 16, wherein the processor is further configured to:
determine a shaped total axle torque request from the primary axle torque target and the secondary axle torque target;
determine a desired primary axle torque from the primary axle torque target, the secondary axle torque target and the shaped total axle torque request;
determine a desired secondary axle torque from the primary axle torque target, the secondary axle torque target and the shaped total axle torque request;
determine a primary axle torque command and a primary axle power used from the desired primary axle torque and the secondary axle reserved power;
determine a secondary axle torque command from the primary axle torque command, the primary axle power used and the desired secondary axle torque;
control the primary axle using the primary axle torque command; and
control the secondary axle using the secondary axle torque command.

18. The vehicle of claim 17, wherein the processor is further configured to determine a total axle torque command from the primary axle torque command and the secondary axle torque command and determine the shaped total axle torque request at a subsequent time using the total axle torque command.

19. The vehicle of claim 17, wherein the processor is further configured to fill the raw total axle torque request using the secondary axle reserved power when the primary axle torque command does not fill the desired primary axle torque.

20. The vehicle of claim 15, wherein the processor is further configured to adjust an axle torque split between the primary axle and the secondary axle to control a sum of the primary axle torque target and the secondary axle torque target.
